(19) United States
(12) Patent Application Publication
(10) Pub. No.: US 2026/0201786 A1
(43) Pub. Date: Jul. 16, 2026

(54) Extending Life of Frac, Stimulation (acid), Gravel Packing, and Mud Pump Valves through Design and Materials: Phase & Chemistry Controlled Alloy Body with Meta Material Seals

(71) Applicants: Ting Roy, Sugar Land, TX (US); Anil Singh, Houston, TX (US); Kamel Ben Naceur, Houston, TX (US); Indranil Roy, Sugar Land, TX (US)

(72) Inventors: Ting Roy, Sugar Land, TX (US); Anil Singh, Houston, TX (US); Kamel Ben Naceur, Houston, TX (US); Indranil Roy, Sugar Land, TX (US)

(21) Appl. No.: 19/452,098

(22) Filed: Jan. 16, 2026

Related U.S. Application Data
(60) Provisional application No. 63/746,233, filed on Jan. 16, 2025.

(51) Int. Cl. E21B 43/26; F04B 53/10

(52) U.S. Cl. CPC E21B 43/2607; F04B 53/1025

(57) ABSTRACT

A reciprocating valve for use in a hydraulic fracking, stimulation, or mud pump environment within a fluid end. The reciprocating valve has a seat and a valve body. The valve body reciprocates up and down within the seat at a high frequency, and a fluid flow from an oil well below the valve flows between the valve body and seat. The valve body includes a seal insert that absorbs a portion of the shock of striking the seat. The seal insert may be a compound META seal having a scaffold portion made of a foaming material with open cells, and a filler material such as a polymer that is molded onto and into the scaffold portion. The META seal insert demonstrates superior wear resistance, vibration characteristics, and erosion resistance.

### CROSS-REFERENCE TO RELATED PATENT APPLICATIONS

This patent application claims the benefit of U.S. Provisional Patent Application Ser. No. 63/746,233 entitled “EXTENDED LIFE FRAC, STIMULATION, AND MUD PUMP VALVES” filed Jan. 16, 2025 which is incorporated herein by reference in its entirety.

### TECHNICAL FIELD

The present disclosure is related to a valve for a reciprocating pump, and in particular to a valve, valve seal insert, and seat for use in suction or discharge valve assemblies of a pump fluid end.

### BACKGROUND

It is common knowledge that downhole Oil & Gas environments are corrosive and abrasive, subjecting deployed tools to general weight loss, pitting, environmental cracking and embrittlement due to hydrogen damage due to interaction of alloys with sour gases and fluids with extreme pH swings. Presence of abrasive particulates, rock, sand and silt etc. combined with non-acidic and acidic fluids flowing across hardware and through orifices often results in severe damage of tools to the extent of scraping assets worth millions of dollars. While building resistance corrosion has been fruitful, developing anti-abrasion and anti-wear properties have been a challenge. In a renewed attempt to address this issue, we endeavor synthesizing technologies and invent materials and methods which offers both corrosion and abrasion resistance in hostile downhole conditions.

The rapid frequency and mean time between failures (MTBF) affecting the overall performance of components such as reciprocating-valves and corresponding valve-seats, choke-beans, pump-liners, among other embodiments deployed in abrasive environments is low. Some attempts to improve this number include the use of ultrahard coatings, HVOF, DLC, overlay etc. But these approaches have not yielded the improvements needed. Some consider that the rationale for such poor improvements from conventional approaches is that the hydrodynamic surface forces due to impinging hard-particulates, such as sand-grains, enveloped in frac or stimulation fluids such as slick-water on ultrahard-coatings applied on a softer-substrate. The result is erosion and fracture of the hard-coatings at a microscopic length-scale. In some cases the particulates can cause breach of the coating and subsequent entry of corrosive-fluids between the coating and softer substrate causes crevice-corrosion leading to catastrophic failures.

The need for an erosion resistant seal, for use in a media with fast-flowing abrasive particulates is an immediate need. An example, a seal on a reciprocating valve installed on a pump-truck used in hydraulic stimulation which lasts between 80 and 100 hours. Extending the MTBF of this seal will significantly reduce red-money for any oilfield service-provider.

### SUMMARY

Embodiments of the present disclosure are directed to a valve for use with a suction or discharge valve assembly of a pump fluid end. The valve includes a valve seat having an interior volume and a seat strike face, and a valve body that has a head and a tail. The tail is positioned in the interior volume of the seat and being configured to maintain the valve body in alignment with the seat as the valve body reciprocates between an open position and a closed position along a valve axis. The head has a valve strike face that is complementary with the seat strike face such that the seat strike face and the valve strike face contact one another when the valve is in the closed position, and wherein a space between the seat strike face and the valve strike face defines a fluid path through the reciprocating valve. The valve also includes a seal insert formed onto the valve body and defining a portion of the valve strike face, the seal insert being made of a polymeric resilient material, the seal insert having a seal insert strike face, wherein the seal insert strike face protrudes from the valve strike face such that the seal insert contacts the seat strike face before the valve strike face contacts the seat strike face.

Further embodiments of the present disclosure are directed to a reciprocating valve for use in hydraulic fracturing. The valve includes a seat having an interior volume and a seat strike face and a valve body having a head and a tail. The tail is positioned in the interior volume of the seat and maintains the valve body in alignment with the seat as the valve body reciprocates between an open position and a closed position. The head has a valve strike face that is complementary with the seat strike face such that the seat strike face and the valve strike face contact one another when the valve is in the closed position. A space between the seat strike face and the valve strike face defines a fluid path through the reciprocating valve. The valve also includes a seal insert formed onto the valve body and forming a seal insert strike face that is complementary with the valve strike face, wherein the seal insert protrudes from the valve strike face such that the seal insert strike face contacts the seat strike face before the valve strike face.

Further embodiments of the present disclosure are directed to a valve for use with a suction or discharge valve assembly of a pump fluid end. The valve includes a seat having an interior volume and a seat strike face, and a valve body having a head and a tail, the tail being positioned in the interior volume of the seat and being configured to maintain the valve body in alignment with the seat as the valve body reciprocates between an open position and a closed position. The head has a valve strike face that is complementary with the seat strike face such that the seat strike face and the valve strike face contact one another when the valve is in the closed position. A space between the seat strike face and the valve strike face defines a fluid path through the reciprocating valve. The valve also includes a seal insert formed onto the valve body and forming a seal insert strike face that is complementary with the valve strike face, wherein the seal insert protrudes from the valve strike face such that the seal insert strike face contacts the seat strike face before the valve strike face.

Yet other embodiments of the present disclosure are directed to a valve for use with a suction or discharge valve assembly of a pump fluid end. The valve includes a valve seat having a seat strike face, and a valve body having a valve strike face. The pump fluid end oscillates the valve between an open and closed position, and the valve strike face contacts the seat strike face when the valve is in a closed position. The valve also includes a seal insert attached to the valve body and forming at least a portion of the valve strike face, the seal insert comprising a scaffold portion made of a foaming material having open cells formed therein, and a filler portion made of a moldable material that substantially fills the open cells of the foaming material.

### BRIEF DESCRIPTION OF THE FIGURES

FIG. 1 is a cross section of a reciprocating valve according to embodiments of the present disclosure.

FIG. 2A is a cross-sectional view of the valve body according to embodiments of the present disclosure.

FIG. 2B is a depiction of a valve body inverted according to embodiments of the present disclosure.

FIG. 3 is a valve shown without a seal insert according to embodiments of the present disclosure.

FIG. 4 shows the valve body of the present disclosure with a seal insert applied.

FIG. 5 shows the seat strike face contacting the seal insert while a gap remains between the valve strike face and the seat strike face according to embodiments of the present disclosure.

FIG. 6 displays a pinching effect that may happen due to the deflection of the seal insert contacting the seat strike face according to embodiments of the present disclosure.

FIG. 7 shows an embodiment in which the seal insert does not protrude beyond the valve strike face and instead is generally parallel with the seat strike face according to embodiments of the present disclosure.

FIG. 8 shows an embodiment in which the valve body includes a relief cavity according to embodiments of the present disclosure.

FIG. 9 shows an embodiment of the valve body that includes a relief cavity that has a rectangular shape according to embodiments of the present disclosure.

FIG. 10 shows an embodiment including a META seal insert according to embodiments of the present disclosure.

FIG. 11 is a chart showing the values of wear rates of selected specimens of epoxy infused copper OCMF according to embodiments of the present disclosure.

FIG. 12 is a chart showing the wear rates of EP-Gr-F40 and EP-Gr as a function of pressure at 0.26 m/s according to embodiments of the present disclosure.

FIG. 13 shows a valve body in partial cross-section in which the META seal insert is formed into a relief cavity according to embodiments of the present disclosure.

FIG. 14 shows a valve body and META seal insert in partial cross-section according to further embodiments of the present disclosure.

FIG. 15 shows a valve body and META seal insert in partial cross-section according to further embodiments of the present disclosure.

FIG. 16 is a cross-section view of a META seal insert according to embodiments of the present disclosure.

FIG. 17 is a scaffold portion made of a foamed material that has been filled with a polymer portion according to embodiments of the present disclosure.

### DETAILED DESCRIPTION

Below is a detailed description according to various embodiments of the present disclosure. The present disclosure is directed to composites stemming from a matrix that is metallic, polymeric or a combination thereof or an agglomeration of nanocrystalline particulates exhibiting unique properties where the addition of one or more phases which can be anything from bulk metallic glasses or carbon nanotubes are unique materials. A range of size classified ceramic particulates to industrial diamonds, have been used to impart novel characteristics by augmenting strength, modulus, abrasion resistance stiffness, coefficient of thermal expansion, thermal and electrical conductivity, and wear resistance, dynamic response e.g. fatigue and crack blunting properties, among others. With the advent of nanomaterials, nanocomposites are envisioned, and are being developed, with properties that overcome the limitations for metals or composites that contain micron scale reinforcements. For example, carbon nanotubes have been shown to exhibit ultra-high strength and modulus and have anisotropic electrical conductivity. The development of Metal Matrix Nanocomposites (MMNCs), however, is still in its infancy. The MMNCs synthesized to date include B4C, SiC, Al2O3, Y2O3, CNT, Diamond among others, often prepared through powder metallurgy processing, and solidification processing. To be noted, second phase additives, especially if designed to a particle size distribution of −325 mesh, may be dual use and need to adhere to regulatory and export compliances.

This disclosure is directed to a polymer (Rubber for example HNBR or its flourinated variations; polyurethane (PU) or equivalent sealing materials) filled meta-material, for erosion-resistant reciprocating-valves. The design encompasses a polymer seal filled in an Open cell Metallic (or non metallic) Foam (OCMF) or Metal Rubber or 3D-printed flexible lattice-structure, wherein the polymer is designed to suspend second-phase particulates resisting abrasive wear when subjected to impingement of sand-particles and it's like. Kevlar and Aramide fibers, Graphene, Carbides, nitrides, borides among other ultra-hard dispersoids are strategically added for different property enhancements. Other classified metallic-powders, cermet's, carbon nanotubes, whiskers, graphene and its derivatives among other fiber-blankets, are layered to offer structural support and improved modulus. During actuation, the PUMMnC offers a strategic combination of hardness, pliability, and erosion-resistance to perform effectively as a sealing-element.

Molds to accommodate commonly used (P4/P5) reciprocating frac-pump valves, for injection of select PU-composites has been designed and manufactured. A meta-material, 3D printed, expandable truss structure with layered fiber-sheets of graphene and its likes have also been designed to serve as a scaffold for in-filling of the interstitial spaces between trusses. Abrasives and other second phase particulates with tailored Hall Flow (fluidity) are infilled in selected PU-melt, the composite subsequently injection-molded into the truss-structure. Solidified embodiment has a hardness, a minimum of 95 Shore-A (resembling a plastic), rather between 60-75 Shore-D. Second-phase inclusions, their density and strategic integration of fiber-blankets have demonstrated potential to offer significantly improved abrasion-resistance, compared to virgin-PU.

This disclosure is directed to a hybrid-complex, a meta-material stemming from strategic synthesis of powder-metals, hard-particulates and polymeric-matter have been conceived and designed. The high-strength, improved-modulus metal-matrix nanocomposites wherein one or more phases can provide erosion-resistance is disruptive and enables the design of embodiments that exceed previous attempts to improve the MTBF for such components.

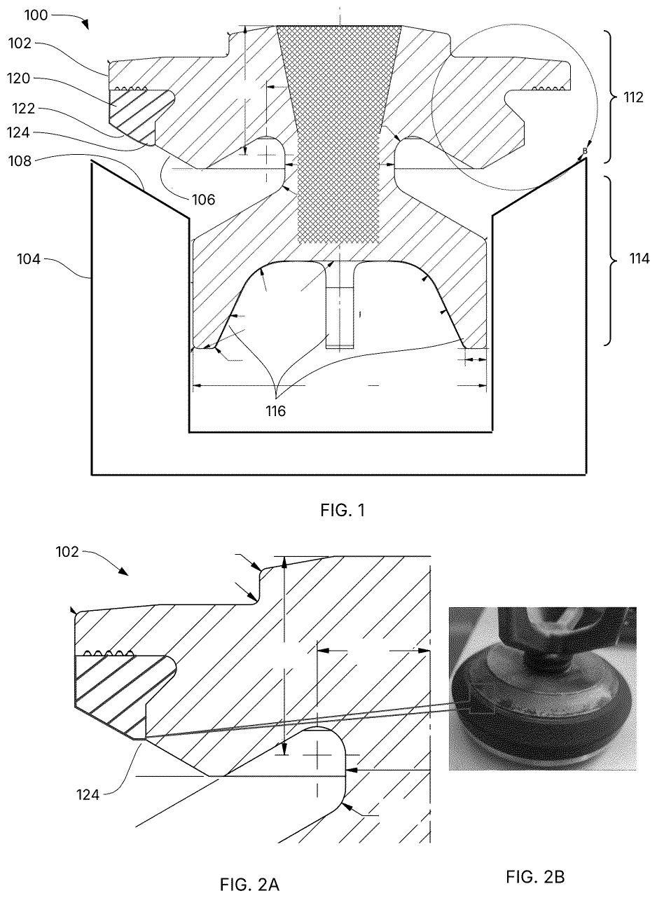

FIG. 1 is a cross section of a reciprocating valve 100 according to embodiments of the present disclosure. The reciprocating valve 100 may be referred to also as a valve 100. It includes a valve body 102 and a valve seat 104. The reciprocating valve 100 is deployed within a fluid end which is a large structure used in frac and stimulation operations in the oil and gas industry to manage the flow of fluid from an oil well. In many common applications the reciprocating valves such as this are used in pairs, a first reciprocating valve on the inlet side, and a second reciprocating valve on the outlet side. The reciprocating valves of the present disclosure can be used interchangeably in the inlet and outlet side in most fluid end configurations.

The valve body 102 is moved up and down relative to the valve seat 104 which remains stationary relative to the fluid end. The valve body 102 has a valve strike face 106, and the seat 104 has a seat strike face 108. These strike faces are the portion of the reciprocating valve 100 that contact one another as the valve 100 is used. This view is a cross-section, and as such it is understood that the strike faces are revolved sections around the generally circular shape of the valve 100. The fluid flows from below and into the valve seat 104 and ultimately between the strike faces and upward away from the valve 100. The valve 100 reciprocates at a high frequency, and the fluid through the valve 100 can contain any combination of oil, gas, water, and particulates. The fluid through rate of these reciprocating valves is also high. The high flow rates, the high frequency of operating the valve 100, and the particulates in the fluid flow create a hostile environment that is the cause of failure for the reciprocating valve 100.

The valve body 102 comprises a head 112 and a tail 114. The head 112 includes the valve strike face 106 and the remainder of the supporting material. The head 112 interfaces with a biasing member (not shown) such as a spring above the head 112 that is used to bias the valve 100 toward a closed position. The tail 114 includes crown-like legs 116 that are sized to fit within the valve seat 104 and to maintain the valve body 102 in alignment with the valve seat 104 as the valve body 102 moves up and down relative to the valve seat 104.

The valve 100 includes a seal insert 120 that forms a portion of the valve strike face 106. The seal insert 120 is made of a polymeric material that cushions the impact force of the reciprocating valve 100 as it rapidly opens and closes. The portion of the seal insert 120 that contacts the seat strike face 108 is referred to as the seal insert strike face 122. In some embodiments the seal insert strike face 122 is not parallel with the valve strike face 106; rather, it protrudes downwardly such that the seal insert strike face 122 contacts the seat strike face 108 before the valve strike face 106 contacts the seat strike face 108. The polymeric material of the seal insert 122 allows the seal insert 122 to deflect to absorb some of the impact. In the depicted embodiment the seal insert 122 protrudes from the valve strike face 106 and has a parabolic shape that arcs upward and toward an asymptote that is parallel with the seat strike face 108 and the valve strike face 106. The protrusion of the seal insert outward from the plane of the valve strike face 106 is the seal insert protrusion 124.

FIG. 2A is a cross-sectional view of the valve body 102 according to embodiments of the present disclosure. FIG. 2B is a depiction of a valve body inverted according to embodiments of the present disclosure. The wear on the valve is evident in FIG. 2B.

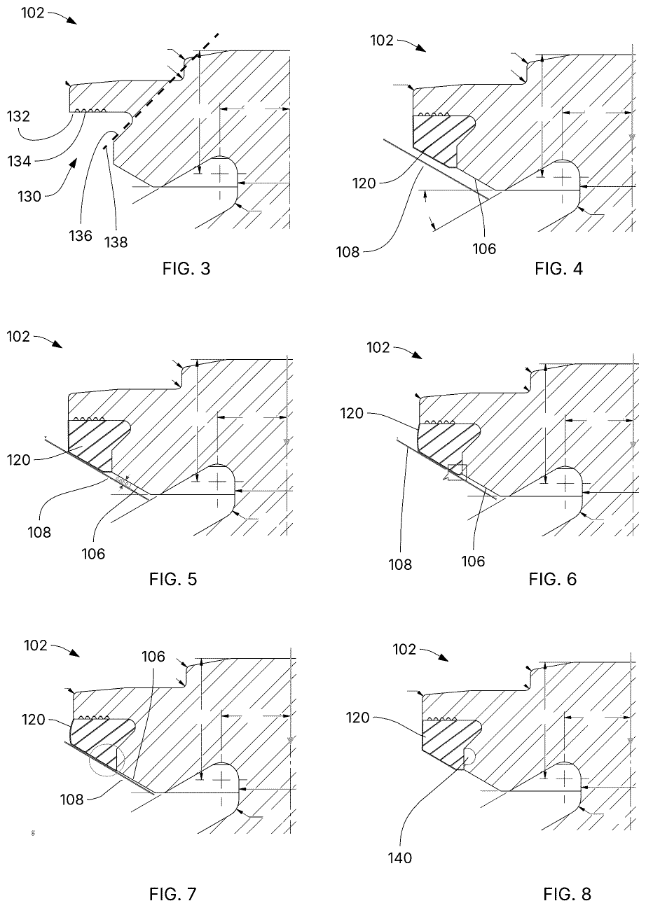

FIGS. 3-15 are a partial, cross-sectional views of a valve body 102 according to embodiments of the present disclosure. FIG. 3 is shown without a seal insert. The valve body 102 includes an anchoring recess 130 that receives the seal insert. The anchoring recess 130 includes a floor 132 which may include grooves 134 that promote adhesion with the seal insert. The anchoring recess 130 also includes an anchor face 136 oriented at an anchor angle 138 relative to a valve axis, which in FIGS. 1-3 is vertical relative to the viewer. The anchor angle 138 can be larger or smaller than the approximate 45 degree angle shown here. A more acute angle provides more of a secure hold to the seal insert; a more obtuse angle provides a less secure hold, but may cause less stress and deflection on the seal insert as the valve operates.

FIG. 4 shows the valve body 102 of the present disclosure with a seal insert 120 applied. The seal insert 120 protrudes from the valve body 102 at an angle approximately perpendicular to the valve axis. The seat strike face 108 is represented here as a line that is generally parallel with the valve strike face 106. It can be seen that the protruding portion of the seal insert 120 will contact the seat strike face 108 first, and the valve strike face 106 will contact slightly after.

FIG. 5 shows the seat strike face 108 contacting the seal insert 120 while a gap remains between the valve strike face 106 and the seat strike face 108. In this embodiment the gap is approximately 0.02-0.01 inches.

FIG. 6 displays a pinching effect that may happen due to the deflection of the seal insert 120 contacting the seat strike face 108. The seal insert 120 can pinch into the gap between the seat strike face 108 and the valve strike face 106.

FIG. 7 shows an embodiment in which the seal insert 120 does not protrude beyond the valve strike face and instead is generally parallel with the seat strike face 108. The pinching is minimized, but the seal insert 120 is able to absorb less of the impact forces in this configuration.

FIG. 8 shows an embodiment in which the valve body 102 includes a relief cavity 140. The relief cavity 140 is within the valve body 102 and underneath the seal insert 120. The relief cavity 140 is formed into the valve body 102 before applying the seal insert 120 to the valve body 102. The relief cavity allows the seal insert 120 to deflect into the relief cavity 140, which mitigates or eliminates the pinching effect that the seal insert 120 can experience without the relief cavity 140.

FIG. 9 shows an embodiment of the valve body 102 that includes a relief cavity 140 that has a rectangular shape. The size and shape of the relief cavity 140 can depend on the needs of a given application. A larger relief cavity 140 can accommodate a larger seal insert which will deflect more than a smaller seal insert.

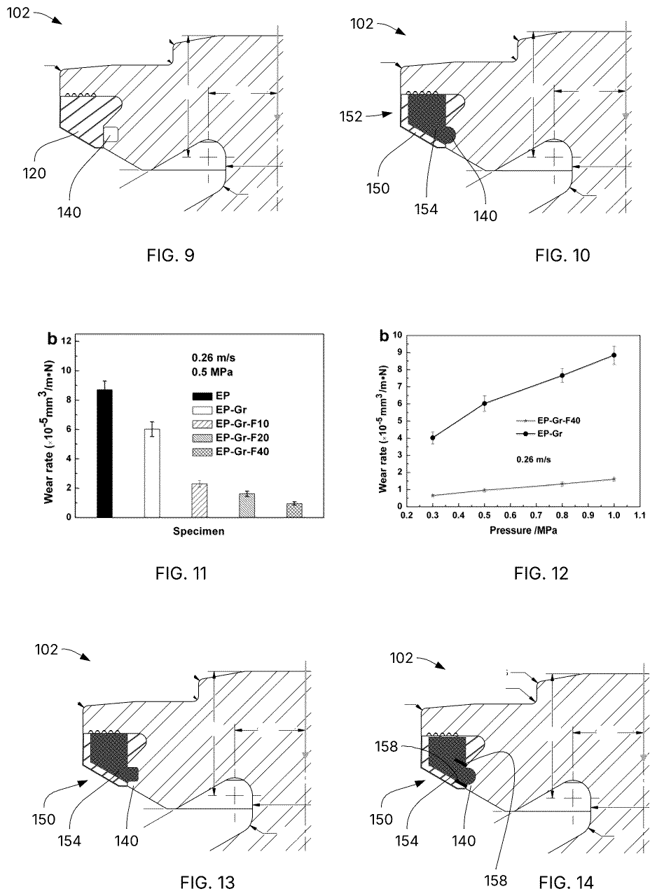

FIG. 10 shows an embodiment including a META seal insert 150 according to embodiments of the present disclosure. The META seal insert 150 is compound because it includes two portions: a polymer portion 152 and a scaffold portion 154. The scaffold portion is made of an open cell metallic foam material. The scaffold portion 154 can include open cells that can be filled with the polymer portion 152. In some embodiments the scaffold portion substantially completely filled with the polymer material. The polymer material may be injection molded around the scaffold portion 154, and the META seal insert 150 is then installed onto the valve body 102. In other embodiments the scaffold portion 154 is formed and secured to the valve body 102, and thereafter the polymer component 152 is injection molded in place around and into the scaffold portion 154.

The scaffold component is made from a foamed material. In some embodiments the foamed material is an open cell metallic foam (OCMF) (suitable for use with a metal material) or metal rubber (MR) (suitable for use with a non-metallic material. The scaffold portion 154 can have a tailored porosity (pores per inch or PPI), a tailored permeability (Darcy), a tailored density or a tailored specific gravity. Materials can include Ni, Fe, Ti, Cu etc. The mechanical and/or corrosion properties are also tailorable. The polymer portion 152 that fills the foamed material infiltrates the scaffold component 154 to completely or partially fill the scaffold portion 154. In some embodiments the polymer portion 152 seal can be pre-molded and pressed on to the valve body 102 wherein the polymeric portion 152 partially infiltrates the scaffold. In other embodiments the entire seal insert 120 may be compression or injection molded onto the valve body 102 with the scaffold portion 154 in place. In such embodiments the polymer portion 152 infiltrates completely (or as nearly as practicable) into the scaffold portion 154 and becomes an integral part of the META seal insert 150. In both cases the open cellular scaffold structure will accommodate the expansion of seal during deformation and fatigue cycle and mitigate tearing, and thus loss of material. In some embodiments the scaffold portion 154 extends into the relief cavity 140.

FIG. 11 is a chart showing the values of wear rates of selected specimens of epoxy infused copper OCMF with 10 to 40 PPI at a velocity of 0.26 m/s and a pressure of 0.5 MPa. When compared to EP or EP-matrix polymer EP-Gr, the epoxy filled 40 ppi Cu OCMF manifests 6× to 8× better wear properties. FIG. 12 is a chart showing the wear rates of EP-Gr-F40 and EP-Gr as a function of pressure at 0.26 m/s. This chart also demonstrates that the effect of pressure on OCMF infiltered polymer composite is far superior (8× to 9×) better under increasing load.

FIG. 13 shows a valve body 102 in partial cross-section in which the META seal insert 150 is formed into a relief cavity 140. The relief cavity 140 and the scaffold component 154 is formed to a rectangular shape that occupies the relief cavity 140.

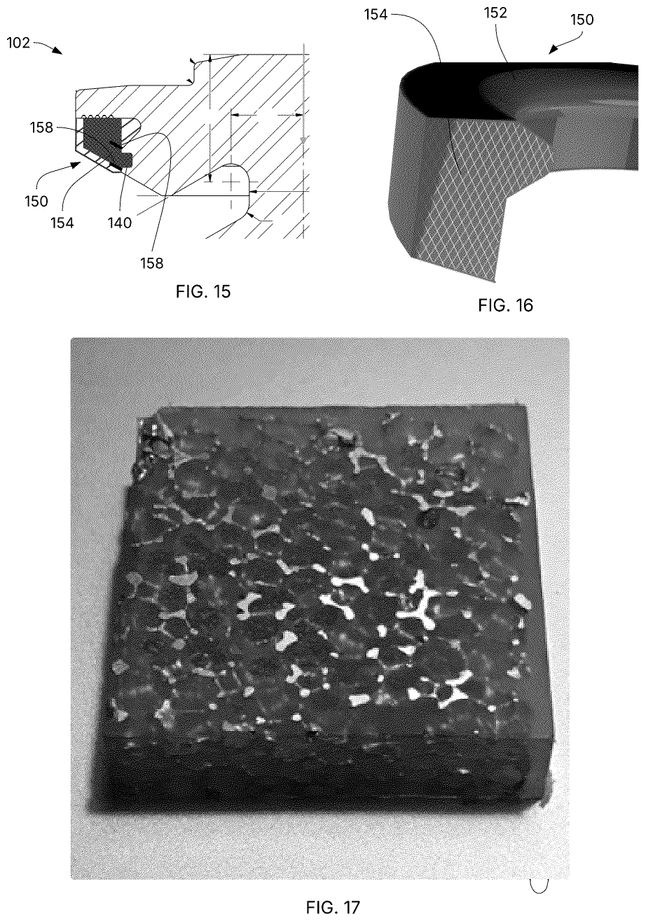

FIGS. 14 and 15 show a valve body 102 and META seal insert 150 in partial cross-section according to further embodiments of the present disclosure. The META seal insert 150 further includes metal fins 158 that act as fatigue dampeners and wear plates. In cases in which the META seal insert 150 wears away partially, the metal fins 158 are a bulwark against further wear and loss of material.

FIG. 16 is a cross-section view of a META seal insert 150 according to embodiments of the present disclosure. The META seal insert 150 includes a scaffold portion 154 that extends the entirety of the volume of the META seal insert 150, and the polymer portion 152 is flowed around and into the scaffold portion 154.

FIG. 17 is a scaffold portion 154 made of a foamed material that has been filled with a polymer portion 152. The open cells are relatively large, so a large portion of the volume is accounted for by the polymer portion 152.

Composites stemming from a matrix that is metallic, polymeric or a combination thereof or an agglomeration of nanocrystalline particulates exhibiting unique properties where the addition of one or more phases which can be anything from bulk metallic glasses or carbon nanotubes are unique materials. A range of size classified ceramic particulates to industrial diamonds, have been used to impart novel characteristics by augmenting strength, modulus, abrasion resistance stiffness, coefficient of thermal expansion, thermal and electrical conductivity, and wear resistance, dynamic response e.g. fatigue and crack blunting properties, among others. With the advent of nanomaterials, nanocomposites are envisioned, and are being developed, with properties that overcome the limitations for metals or composites that contain micron scale reinforcements. For example, carbon nanotubes have been shown to exhibit ultra-high strength and modulus and have anisotropic electrical conductivity. The development of Metal Matrix Nanocomposites (MMNCs), however, is still in its infancy. The MMNCs synthesized to date include B4C, SiC, Al2O3, Y2O3, CNT, Diamond among others, often prepared through powder metallurgy processing, and solidification processing. To be noted, second phase additives, especially if designed to a particle size distribution of −325 mesh, may be dual use and need to adhere to regulatory and export compliances.

Some embodiments of the present disclosure feature a polymer (Rubber for example HNBR or its flourinated variations; polyurethane (PU) or equivalent sealing materials) filled meta-material, for erosion-resistant reciprocating-valves. The design encompasses polymer seal filled in a Open cell Metallic (or non metallic) Foam (OCMF) or Metal Rubber or 3D-printed flexible lattice-structure, wherein the polymer is designed to suspend second-phase particulates resisting abrasive wear when subjected to impingement of sand-particles and other particulates. Kevlar and Aramide fibers, Graphene, Carbides, nitrides, borides among other ultra-hard dispersoids are strategically added for different property enhancements. Other classified metallic-powders, cermet's, carbon nanotubes, whiskers, graphene and its derivatives among other fiber-blankets, are layered to offer structural support and improved modulus. During actuation, the PUMMnC offers a strategic combination of hardness, pliability, and erosion-resistance to perform effectively as a sealing-element.

Molds to accommodate commonly used (P4/P5) reciprocating frac-pump valves, for injection of select PU-composites has been designed and manufactured. A meta-material, 3D printed, expandable truss structure with layered fiber-sheets of graphene and its likes have also been designed to serve as a scaffold for in-filling of the interstitial spaces between trusses. Abrasives and other second phase particulates with tailored Hall Flow (fluidity) are infilled in selected PU-melt, the composite subsequently injection-molded into the truss-structure. Solidified embodiment has a hardness, a minimum of 95 Shore-A (resembling a plastic), rather between 60-75 Shore-D. Second-phase inclusions, their density and strategic integration of fiber-blankets have demonstrated potential to offer significantly improved abrasion-resistance, compared to virgin-PU.

The present disclosure is directed to a hybrid-complex, a meta-material stemming from strategic synthesis of powder-metals, hard-particulates and polymeric-matter. The result is high-strength, improved-modulus metal-matrix nanocomposites wherein one or more phases can provide erosion-resistance.

Embodiments of the present disclosure are directed to materials and method for extending life of frac pump, acid stimulation, gravel pack and mud pump valve seats employing phase-controlled diffusion-based surface modified alloy body with meta material seals for erosion and abrasion resistance. Embodiments of the present disclosure are directed to a valve for use on a reciprocating pump assembly for example a fluid end in either the suction or discharge port. The valve can include a Valve body designed with two ends, the top half with a machined anchor cap, wherein a spring is installed, a middle section with a recessed machined feature on the valve body accommodating and defining a seal which is removably molded, bonded to the body or pressed on, and an insert seal installed onto the recessed space on the middle section of valve body, wherein the seal forms a first strike face when the valve mates with a sealing seat defined with respect to the valve, either embodiment removably installed.

Embodiments of the present disclosure are directed to a bottom section of a valve comprising a seat strike face, a stopping surface engaging with the defined seat when the valve continues its travel after first contact of seal with defined seat. In some embodiments the valve employs guide legs or other analogous feature centralizing the valve during the reciprocating motion of the embodiment during operations.

Embodiments of the present disclosure are directed to a reciprocating valve in which a seal insert has a protrusion or ledge at 90 degrees (perpendicular) to valve axis. Accordingly the seal The introduction of such a feature enables the seal to engage first engages with the valve seat which acts as a wiper for enhanced seal-ability, before the bottom section strike face is stopped by the valve body. This protrusion or ledge intersects with a 30-degree seal surface and forms a linear region extended circumferentially about the valve body. It offers a stress riser during high cycle fatigue of the seal, also when partially extending into the extrusion gap between valve and seat seal surface, resulting into wear and removal of seal material during operations, compromising the life of the valve.

Embodiments of the present disclosure are directed to a reciprocating valve including a seal insert having a parabolic spline with an obtuse angle to offset and overcome this detriment is introduced. The parabolic spline with an obtuse angle introduced onto the seal offsets the bottom section strike face between 0.02 to 0.1 (twenty to hundred thousand of an inch) between first contact and stopping at defined seat.

The article of claim 1, wherein a buffer space is machined onto valve body to accommodate compressed polymer when seal deforms, for example (a) a semicircular cavity (b) a rectangular cavity. Position, size and shape of the cavity is designed and tailored to reduce stresses due to fatigue allowing seal to maintain shape during deformation wear. This will abet extending the life of valve seal when deployed in aggressive operating environments (FIG. 8).

Embodiments of the present disclosure are directed to a reciprocating valve wherein the buffer space or cavity machined to accommodate compressed polymer when the seal insert deforms, is now filled with a foamed material, for examples for metallic, an open cell metallic foam (OCMF) or metal rubber (MR) or for a non-metallic material, a scaffold, wherein the scaffold can have tailored porosity (pore volume), permeability (Darcy), density or specific gravity (kg/m3), materials (Ni, Fe, Ti, Cu etc.), mechanical and corrosion properties.

Embodiments of the present disclosure are directed to a structure that can be infiltrated by a polymeric seal material, completely or partially. Additionally, the seal insert can be pre-molded and pressed on to the valve body wherein the seal insert partially infiltrates the scaffold portion. Alternately, the entire seal insert may be compression or injection molded onto the valve body with the scaffold portion in place. The seal insert material infiltrates partially or completely into the scaffold portion and becomes an integral part of the seal insert structure. In both cases the open cellular scaffold structure will accommodate the expansion of seal during deformation/fatigue cycle and mitigate tearing, thus loss of material and dampening any shocks and fatigue stresses.

Embodiments of the present disclosure are directed to a scaffold structure to be anchored in a seal insert recess to augment the mechanical properties of the META seal, wherein it is established elsewhere that the META seal is capable of absorbing shock and vibrations during operations (up-to 100% improvement) and wear (up-to 8× improvement). Additionally metallic fins of tailored shapes and dimensions to be machined as integral part of the valve body (parallel to the strike face of the valve) wherein they will act as fatigue dampeners and wear plates. With loss of seal material, wherein when polymer is removed and the wear plate is encountered, the fin (wear plate) will resist erosion of the seal far better, extending life of the valve.

Embodiments of the present disclosure are directed to a valve with seal element molded in form of a parabolic spline with an obtuse angle is reinforced by a metal rubber (MR), carbon fiber, Kevlar, aramid fiber open cellular (3D printed, electrodeposited, foamed or otherwise), metallic or nonmetallic, with or without a strengthening metallic or nonmetallic internal strengthening element (for example a ring) with extension into the body for effective anchoring, designs of which (cavity) can be tailored for stable grip on the reinforcement. Additionally, the internal of the seal may be reinforced with a partially or completely filled open/closed cell homogeneous/hybrid structure to mitigate abrasion wear of the seal insert.

Embodiments of the present disclosure are directed to a valve entirely made from metal foam or equivalent scaffold infiltered with polymeric material on which the seal geometry is compression, transfer or injection molded with or without any machined finish with a MR ring for mitigating fatigue stresses. The design encompasses anchoring two strike face plated onto the composite structure (shown in red (cross hatched). The strike faces are secured to the structure with bolts embedded onto the molded structure. The strike face will have sufficient rebound due to combined superior “Bayshore modulus” of the material and dampening behavior of the hybrid structure. This will help retain the overall shape of the valve and prevent coining (deformation due to momentum transfer, wherein reduced weight of the composite valve helps mitigate the momentum) and wear (again due to the reduced weight and lowering overall frictional forces). This will extend the life of the reciprocating valve in this embodiment. This embodiment with the open cell or equivalent scaffold infiltered with polymeric material will serve to dampen shock and vibrations; additionally act as a buffer to accommodate compressed polymeric seal and mitigating stress due to cyclic fatigue.

Embodiments of the present disclosure are directed to a valve wherein the body of the valve is closed-die forged out of alloy steel (AISI 8620 or equivalent) or cast followed by hot isostatic pressing (HIP) to remove porosity and increase fracture toughness of the part. For example, 8620 steel can be forged around 2250° F. (1232.22° C.) down to approximately 1700° F. (926.67° C.) The alloy is air cooled after forging.

Embodiments of the present disclosure are directed to a method of manufacture for the valve wherein the starting material for closed die forging is solution annealed or homogenized alloy steel (for examples 8620, 4340, 4140 etc.) or if part (valve) is cast, valve is HIPed followed by solution annealing or homogenization.

Embodiments of the present disclosure are directed to normalizing (for example 8620 steel) is conducted at a temperature 1675° F. (913° C.) and quenched. Air cooling is another method of improving machinability in this grade; normalizing might also be used prior to case hardening. This is followed by austenitizing the alloy at around 1525° F. (829° C.) and oil or water quenched depending upon section size and intricacy. Getting a core hardness of 40+Rc the alloy can be tempered at 302° F. (150° C.)—see tempering parameters below:

| Tempering | | Core hardness, Rc | Impact, Ft-lb. (RT) |
|---|---|---|---|
| 1202° F. | (650° C.) | 21 | >117 |
| 1004° F. | (540° C.) | 29 | >76 |
| 797° F. | (425° C.) | 36 | >45 |
| 302° F. | (150° C.) | 43 | >34 |

Embodiments of the present disclosure are directed to a reciprocating valve in which part of the valve mates with the valve seat is Pack Boronized to a hardness>72 Rc, wherein the cased depth is 0.005 to 0.015 inches for boronized and 0.065 to 0.08 for Boro-Carburized. Embodiments of the present disclosure are directed to a reciprocating valve in which the tail and legs of the valve guide the valve body into the valve seat, and are also pack boronized alongside the surface contacting its seat to avoid masking, thus minimize economics of manufacture.

Embodiments of the present disclosure are directed to a reciprocating valve in which closed die forging valve or cast+HIPed valve post solution annealing/homogenizing is gas carburized to a case depth of 0.06 to 0.08 inches, wherein the hardness of material is between 57 to 64 Rc (often >60 Rc). Steps of pack boronizing and gas carburizing can be interchanged; however, the recommended sequence is pack boronizing followed by gas carburizing. This is because (i) Pack boronizing is performed at an elevated temperature of around 1562° F. (850° C.) (often between 1300° F. (704° C.) to 1850° F. (1010° C.) for 1 to 20 hours) and will negate the effects of gas carburizing if done prior (ii) parts will need to be in a vacuum or controlled environment, not to burn off or reduce carbon enriched case, increase part cost.

We claim:

1. A valve for use with a suction or discharge valve assembly of a pump fluid end, the valve comprising:
a valve seat having an interior volume and a seat strike face;
a valve body having a head and a tail, the tail being positioned in the interior volume of the seat and being configured to maintain the valve body in alignment with the seat as the valve body reciprocates between an open position and a closed position along a valve axis, the head having a valve strike face that is complementary with the seat strike face such that the seat strike face and the valve strike face contact one another when the valve is in the closed position, and wherein a space between the seat strike face and the valve strike face defines a fluid path through the reciprocating valve; and
a seal insert formed onto the valve body and defining a portion of the valve strike face, the seal insert being made of a polymeric resilient material, the seal insert having a seal insert strike face, wherein the seal insert strike face protrudes from the valve strike face such that the seal insert contacts the seat strike face before the valve strike face contacts the seat strike face.

2. The reciprocating valve of claim 1 wherein the seal insert strike face comprises a protrusion that extends from the valve strike face outwardly and perpendicularly from the valve axis.

3. The reciprocating valve of claim 1 wherein the seal insert strike face comprises a protrusion that extends from the valve strike face outwardly in a parabolic shape that approaches an asymptote that is generally parallel with the seat strike face.

4. The reciprocating valve of claim 1 wherein the valve body comprises a relief cavity underneath the seal insert, and wherein the seal insert deflects upon contact with the seat strike surface and wherein at least a portion of the seal insert deflects into the relief cavity.

5. The reciprocating valve of claim 1 wherein the seal insert comprises a scaffold portion made of an open cell foaming material and a filler portion that infiltrates the open cells in the scaffold.

6. The reciprocating valve of claim 5 wherein the scaffold is formed onto the valve body and the filler portion is molded around the scaffold and into the open cells of the foaming material.

7. The reciprocating valve of claim 5 wherein the valve body comprises a relief cavity, and wherein the scaffold portion fills at least a portion of the relief cavity.

8. The reciprocating valve of claim 5 wherein the foaming material comprises a metallic foam material.

9. The reciprocating valve of claim 8 wherein the metallic foam material is made from one of nickel; an alloy of nickel and iron; titanium, or aluminum.

10. A reciprocating valve for use in hydraulic fracturing, the valve comprising:
a seat having an interior volume and a seat strike face;
a valve body having a head and a tail, the tail being positioned in the interior volume of the seat and being configured to maintain the valve body in alignment with the seat as the valve body reciprocates between an open position and a closed position, the head having a valve strike face that is complementary with the seat strike face such that the seat strike face and the valve strike face contact one another when the valve is in the closed position, and wherein a space between the seat strike face and the valve strike face defines a fluid path through the reciprocating valve; and
a seal insert formed onto the valve body and forming a seal insert strike face that is complementary with the valve strike face, wherein the seal insert protrudes from the valve strike face such that the seal insert strike face contacts the seat strike face before the valve strike face.

11. The reciprocating valve of claim 10 wherein the seat strike face protrudes from the valve strike face in a parabolic shape that departs from the valve strike face at a substantially perpendicular direction with respect to the strike face and arcs in a parabolic shape toward an asymptote that is generally parallel with the valve strike face.

12. The reciprocating valve of claim 10 wherein the valve body comprises an anchor recess and wherein the seal insert fills the anchor recess.

13. The reciprocating valve of claim 10 wherein the valve body comprises a relief cavity underneath a portion of the seal insert, wherein the seat strike face contacting the seal insert strike face causes the seal insert to deflect, and wherein the relief cavity receives a portion of the deflected seal insert.

14. The reciprocating valve of claim 13 wherein the relief cavity is near a union between the valve strike face and the seal insert strike face.

15. A valve for use with a suction or discharge valve assembly of a pump fluid end, the valve comprising:
a seat having an interior volume and a seat strike face;
a valve body having a head and a tail, the tail being positioned in the interior volume of the seat and being configured to maintain the valve body in alignment with the seat as the valve body reciprocates between an open position and a closed position, the head having a valve strike face that is complementary with the seat strike face such that the seat strike face and the valve strike face contact one another when the valve is in the closed position, and wherein a space between the seat strike face and the valve strike face defines a fluid path through the reciprocating valve; and
a seal insert formed onto the valve body and forming a seal insert strike face that is complementary with the valve strike face, wherein the seal insert protrudes from the valve strike face such that the seal insert strike face contacts the seat strike face before the valve strike face.

16. The valve of claim 15 wherein the seat strike face protrudes from the valve strike face in a parabolic shape that departs from the valve strike face at a substantially perpendicular direction with respect to the strike face and arc in a parabolic shape toward an asymptote that is generally parallel with the valve strike face.

17. The valve of claim 15 wherein the valve body comprises an anchor recess and wherein the seal insert fills the anchor recess.

18. The valve of claim 15 wherein the valve body comprises a relief cavity underneath a portion of the seal insert, wherein the seat strike face contacting the seal insert strike face causes the seal insert to deflect, and wherein the relief cavity receives a portion of the deflected seal insert.

19. The valve of claim 18 wherein the relief cavity is near a union between the valve strike face and the seal insert strike face.

20. A valve for use with a suction or discharge valve assembly of a pump fluid end, the valve comprising:
a valve seat having a seat strike face;
a valve body having a valve strike face, wherein the pump fluid end oscillates the valve between an open and closed position, wherein the valve strike face contacts the seat strike face when the valve is in a closed position; and
a seal insert attached to the valve body and forming at least a portion of the valve strike face, the seal insert comprising a scaffold portion made of a foaming material having open cells formed therein, and a filler portion made of a moldable material that substantially fills the open cells of the foaming material.

21. The valve of claim 20 wherein the scaffold is made of an open cell metallic foam, and wherein the filler portion is made of a polymer, and wherein the polymer is molded onto the scaffold to substantially fill the open cells of the open cell metallic foam.

22. The valve of claim 20 wherein the scaffold is an open cell material made from nickel, stainless steel, titanium, or aluminum.

23. The valve of claim 20 wherein the filler material is a polymer blended with functionalized graphene.
